(19) United States
(12) Patent Application Publication
(10) Pub. No.: US 2017/0371360 A1
(43) Pub. Date: Dec. 28, 2017

(54) CONTROL SYSTEM

(71) Applicant: Manetos AB, Stockholm (SE)

(72) Inventors: Jan Johansson, Solna (SE); Henrik Borg, Norsborg (SE)

(73) Assignee: Manetos AB, Stockholm (SE)

(21) Appl. No.: 15/538,351

(22) PCT Filed: Dec. 18, 2015
(86) PCT No.: PCT/SE2015/051374

§ 371 Date: Jun. 21, 2017

(30) Foreign Application Priority Data
Dec. 23, 2014 (SE) 1400607-6

(51) Int. Cl. G05D 23/19; G05D 22/02

(52) U.S. Cl. CPC G05D 23/1917; G05D 22/02

(57) ABSTRACT

The invention relates to an electric system, comprising an electric equipment (1) having a control line (2) arranged to be connected to impedance means (3) as well as to substituting means (7). The substitution means provides an impedance controlled by a first output (8) of a control unit (6), the control unit having polarity probing means (13) arranged to obtain an indication whether a connection of the substituting means to the control line (2) results in a voltage with a positive or negative polarity. The connection of the substituting means (7) is made in dependence on that indication and under influence of a second output (14) of the control unit. According to the invention, the substituting means (7) comprise a series connection of two equivalent impedance networks (15, 16) provided each one with by-pass switching means (17, 18) for a plurality of impedance means (19, 20), each having series connected semiconductor switching means (21, 22) arranged in opposite directions. The impedance networks (15, 16) are controlled by the first output (8) of the control unit (6). The by-pass switching means (17, 18) are arranged to be alternatively activated by the second output (14) of the control unit.)

### TECHNICAL FIELD

The invention relates to a control system in which an electric equipment has a control line arranged to be connected to an impedance means. The control system can be used in a number of applications within the scope of the appended claims, e.g. in indoor climate control installations, in wireless energy transfer systems, in charging systems for electrical vehicles, and in general communication equipment. The control system can be utilized e.g. in order to achieve power adjustment and/or optimisation.

### BACKGROUND OF THE INVENTION

For users in general, and for the global society in particular, less consumption of energy is desirable. There is a need for efficient and reliable power adjustment and/or optimisation in a number of technical fields, such as for test equipment, for calibration of equipment, for general laboratory purposes, and/or for climate control systems.

For example, indoor climate control installations exist in many variations, and these indoor climate control installations represent a considerable consumption of energy. For users in general and for the global society in particular, less consumption of energy is desirable. While new systems can offer energy savings at a maintained level of climate comfort, only a minor part of the installations presently used are likely to be replaced in a near future. Instead of accepting the cost of a new installation, users may choose less comfort so as to reduce the energy consumption. A huge market can be found for an adapter (a control system) that saves energy without loss of climate comfort. According to such a solution described in WO2013070159, relay means are arranged to disconnect the climate influenced impedance means from the control line under influence from an output of a control unit and to instead connect substituting means providing an impedance controlled by a second output of the control unit.

In order to make the adapter as easy to install as possible, the control unit is provided with polarity probing means arranged to obtain an indication whether a connection of the substituting means to the control line results in a voltage with a positive or negative polarity, the connection of the substituting means being made in dependence on that indication and under influence of a third output of the control unit.

The substitution of the climate influenced impedance means presents, however, a problem as it is desirable to have the impedance determined with a high accuracy in spite of great variations in impedance magnitudes and the control line current characteristics. Electromagnetic relay contacts have ageing effects for low-level electric currents. It is a challenge to find a semiconductor switching solution that is good enough at a low cost.

Also, similar problems related to climate control in buildings are present e.g. for climate control equipment in heavy duty vehicles and climate control equipment in mining industry applications.

### SUMMARY OF THE INVENTION

According to the invention, the substituting means comprise a series connection of two equivalent impedance networks provided each one with by-pass switching means for a plurality of impedance means that have series connected semiconductor switching means arranged in opposite directions. The two impedance networks are controlled by a first output of the control unit. The by-pass switching means are arranged to be alternatively activated by a second output of the control unit.

### BRIEF DESCRIPTION OF THE DRAWING

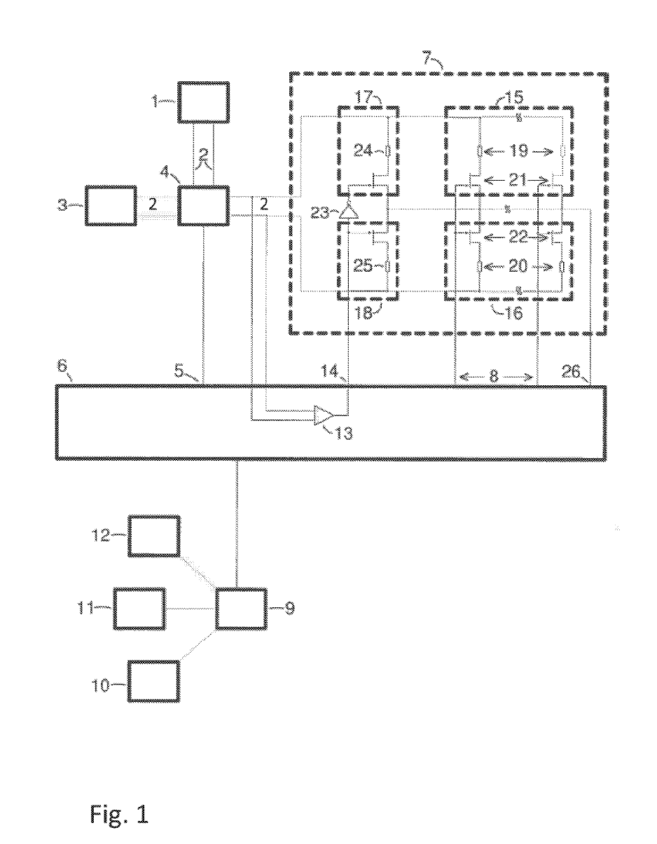

The control system according to the invention will be described with reference made to the drawing (FIG. 1) that shows a principle diagram of a preferred embodiment.

### PREFERRED EMBODIMENT

The drawing shows a principle diagram of an indoor climate control system in which an electric equipment 1, such as e.g. a climate controlling equipment, has a control line 2 normally being connected to climate influenced impedance means 3. The climate influenced impedance means 3 can for example include one or more of a temperature sensor, such as a thermistor, an air humidity (RH) sensor, which can be capacitive and/or resistive, and a carbon dioxide (CO₂) sensor. Switching means 4 are arranged to disconnect the climate influenced impedance means 3 from the control line 2 under influence from a third output 5 of a control unit 6 in favour of substituting means 7. Thereby, an impedance controlled by a first output 8 of the control unit 6 is provided, as is described below. Thus, normally, the climate controlling equipment 1 is coupled to the climate influenced impedance means 3, but can be disconnected by the present invention, whereby the substitution means 7 instead is coupled to climate controlling equipment 1 by the switching means 4. The substitution means 7 is a circuit being able to provide an impedance being controllable by the first output 8 of the control unit 6.

According to an example embodiment, the control unit 6 is connected to a processor 9 arranged to receive information from a plurality of climate influenced information means 10, 11 and 12, that may include one or more of temperature sensors, thermistors, air humidity (RH) sensors, sun radiation sensors, wind sensors, rain sensors, and climate forecast devices. The information can be processed by use of a mathematical model in order to provide the first output 8. The impedance of the substituting means 7 can then be controlled via the first output 8 of the control unit 6. For example, the output 8 can be determined by a mathematical function based on e.g. climate data and possibly also based on a climate control scheme and/or energy tariffs.

The control unit 6 can, as described in WO2013070159, according to an example embodiment, be provided with suitable measuring means (not shown in the FIGURE) for determining in a disconnected mode of the climate influenced impedance means 3 the characteristics of the same in order to control the impedance of the substituting means 7 at least initially, and to more or less frequently verify the characteristics of the influenced impedance means 3. Thus, the characteristics of the influenced impedance means 3 can be measured when it is disconnected from the climate controlling equipment 1. The impedance of the substituting means 7 can then be controlled by the output 8 based at least on the measured characteristics of the influenced impedance means 3.

The control unit 6 is provided with polarity probing means 13 arranged to obtain an indication whether a connection of the substituting means 7 to the control line 2 results in a voltage with a positive or negative polarity on the control line 2. This facilitates an easy installation of the control system according to the present invention. The polarity probing means 13 senses two conductors of the control line 2 and detects a difference voltage between the two conductors. The second output 14 from the polarity probing means 13 therefore depends on which one of the two conductors in control line 2 that has the highest potential.

The connection of the substituting means 7 to the electric equipment 1 is thus made in dependence on the polarity indication from the polarity probing means 13, and under influence of a second output 14 of the control unit. The second output 14 controls which one of two by-pass switching means 17 and 18 in the substitution means 7 that should be activated. An inverter 23 being arranged between the by-pass switching means 17 and 18 has the effect that only one of these by-pass switching means 17 and 18 is activated at a time.

According to the invention, the substituting means 7 comprise a series connection of two equivalent impedance networks 15 and 16, provided each one with one by-pass switching means 17 and 18.

Each one of the impedance networks 15 and 16 includes a plurality of impedance means 19 and 20, each one of the impedance means 19 and 20 being series connected with a semiconductor switching means 21 and 22, respectively. The impedance networks 15 and 16 are arranged in opposite directions, i.e. are mirror-inverted, in respect to control line 2 and signal ground 26. On other words, each one of the impedance networks 15 and 16 may include a number of parallel coupled impedance means 19, 20 being series connected with semiconductor switching means 21, 22, respectively. One terminal for each one of the semiconductor switching means 21, 22 are connected to each other and to the signal ground 26. For example, if each one of the semiconductor switching means 21, 22 comprises a Field Effect Transistor (FET), the two impedance networks 15, 16 are arranged such that the source terminals of the two FETs 21, 22 are connected to each other and to the signal ground 26.

The impedance networks 15 and 16 are controlled by the first output 8 of the control unit 6, and may for example have impedance values chosen in accordance with a logarithmic scale in order to cover a wide impedance range. The by-pass switching means 17 and 18 are arranged to be alternatively activated by the second output 14 of the control unit 6 and the inverter 23, as described above.

An activation of the by-pass switching means 17 eliminates the non-linearities of the impedance network 15, since essentially no current then passes through the impedance network 15 and its transistors 21 due to bypassing through the by-pass switching means 17. Correspondingly, an activation of the by-pass switching means 18 eliminates the non-linearities of the impedance network 16, since essentially no current then passes through the impedance network 16 and its transistors 22 due to bypassing through the by-pass switching means 18.

The impedance means 19 and 20 comprises a number or resistors, e.g. depending on a specification of the climate controlling equipment 1. The number of resistors and their resistance values are chosen in order to achieve parallel couplings resulting in total resistance values with a suitable resolution and precision.

For example, N-channel Field Effect Transistors (FET) can be used for the semiconductor switching means 21 and 22 and the by-pass switching means 17 and 18, as mentioned above.

The by-pass switching means 17, 18 are provided with resistors 24 and 25 that have sufficiently low resistance values, in relation to the lowest generated resistance for the impedance networks 15 and 16, to be used as short circuit links for connecting the negative pole of the control line 2, i.e. the conductor having the lowest potential, to a signal ground 26 of the control unit 6. Thus, the one activated by-pass switching means 17, 18 can here be regarded as a short circuit between the negative pole of the control line 2 and the signal ground 26, thereby causing the above mentioned bypassing through the one activated by-pass switching means 17, 18.

The impedance means 19 and 20 can comprise resistors as in the described exemplified embodiment of the indoor climate control system in order to provide the controllable impedance. The impedance means 19 and 20 can also comprise capacitors and/or inductors according to other embodiments.

The man skilled in the art can also use the control system of the invention for other applications within the scope of the appended claims, as is mentioned above.

The electronic equipment 1 according to the present invention is suitable for implementations in a large number of systems. Such systems may include systems having demands for higher currents and higher voltages, and may be polarity independent. Such systems may also include systems arranged for lower currents and/or voltages. The invention is also suitable for implementation in wireless energy transfer systems, in systems for charging of electrical vehicles and/or in general communication equipment. The invention is also suitable for implementation in climate control equipment in heavy duty vehicles and/or climate control equipment in mining industry applications. The invention is also suitable for implementation in test equipment, in calibration systems, and/or in general laboratory equipment.

1. Control system comprising an electric equipment (1) having a control line (2) arranged to be connected to impedance means (3) as well as to activate substituting means (7) providing an impedance controlled by a first output (8) of a control unit (6), the control unit having polarity probing means (13) arranged to obtain an indication whether a connection of the substituting means (7) to the control line (2) results in a voltage with a positive or negative polarity, the connection of the substituting means (7) being made in dependence on that indication and under influence of a second output (14) of the control unit, the substituting means (7) comprising a series connection of two equivalent impedance networks (15, 16) provided each one with by-pass switching means (17, 18) for a plurality of impedance means (19, 20) that have series connected semiconductor switching means (21, 22) arranged in opposite directions and controlled by the first output (8) of the control unit, the by-pass switching means (17, 18) being arranged to be alternatively activated by the second output (14) of the control unit.

2. Control system according to claim 1, wherein the plurality of impedance means comprise resistors.

3. Control system according to claim 1, wherein the plurality of impedance means comprise capacitors

4. Control system according to claim 1, wherein the plurality of impedance means comprise inductors.
